(19) United States
(12) Patent Application Publication
(10) Pub. No.: US 2006/0167731 A1
(43) Pub. Date: Jul. 27, 2006

(54) Automatically scheduling meetings

(75) Inventors: Ken A. Nishimura, Fremont, CA (US); Ian Hardcastle, Sunnyvale, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(73) Assignee: AGILENT TECHNOLOGIES, INC, Loveland, CO (US)

(21) Appl. No.: 11/044,342

(22) Filed: Jan. 27, 2005

(51) Int. Cl. G05B 19/418

(52) U.S. Cl. 705/8

(57) ABSTRACT

Methods, machines, and machine-readable media storing machine-readable instructions for automatically scheduling meetings are described. In one aspect, a meeting request is received. The meeting request specifies a meeting duration, a set of non-fungible resources, and a number of required fungible resources of a specified type. A potential-meeting-time set of timeslots is determined. The potential-meeting-time set corresponding to a union of a first set of timeslots during each of which at least some of the non-fungible resources are available and a second set of timeslots corresponding to an intersection of each timeslot during which at least the specified number of fungible resources of the specified type are available. At least one timeslot having a duration at least as long as the specified meeting duration is identified in the potential-meeting-time set.

### BACKGROUND

Electronic meeting schedulers have been developed that allow a user to automatically schedule a meeting with a group of invitees who use personal electronic calendars to keep track of their free and busy times. In a typical approach, a user schedules a meeting by submitting a meeting request form that includes an identification of the invitees, one or more dates and times, and a duration for the meeting. The electronic meeting scheduler accesses the electronic calendars of the proposed invitees and determines whether or not a meeting having the proposed duration and during which all of the invitees are available to attend can be scheduled. If such a meeting can be scheduled, the electronic meeting scheduler automatically invites the invitees to the meeting either by sending an electronic notification to the invitees or by automatically placing the meeting on the personal electronic calendars of the invitees.

In addition to scheduling a meeting based on the availability of a group of invitees, some electronic meeting schedulers allow a user to schedule a meeting based on the availability of meeting rooms and other resources.

In one approach, an electronic meeting scheduler treats people, rooms, and resources as invitees. The electronic meeting scheduler automatically determines whether all of the invitees that have been designated in a meeting request are available at the desired date, time, and duration based on profile documents that are stored in a database for each invitee. Information such as room capacity and built-in resources are taken into account when determining the availability of a room. If there is no time interval during which all of the invitees are available, the electronic meeting scheduler determines a “best fit” meeting by incrementally reducing the set of invitees based on weights that the user assigns to each invitee until a suitable meeting date and time is found.

In another approach, a meeting scheduling/meeting room reservation linkage system tentatively schedules for a desired group of attendees a meeting date, a meeting time, a desired meeting room, and a set of desired meeting room equipment. The linkage system concurrently determines if the attendees can attend the tentative meeting and if a desired meeting room is available. In this regard, the linkage system treats the meeting room as a prospective attendee. The linkage system determines the availability of the attendees by electronically checking the electronic calendars of the prospective attendees and determines the availability of the meeting room by electronically checking the electronic calendar maintained for the desired meeting room. If there is a conflict with one or more of the attendees making the meeting, the availability of the meeting room, or the availability of the desired equipment, the linkage system purportedly attempts to automatically determine another tentative meeting date, time, room, and equipment until such a meeting date, time, equipment, and room are agreed lo upon.

The above-described electronic meeting schedulers accommodate the need to simultaneously schedule meetings based on invitee availability and meeting room availability by treating invitees and meeting rooms in the same way. Since these approaches are designed to determine meeting times when all of the invitees are available (or when a suitable set of invitees corresponding to a minimal weighted score is determined), however, these approaches require users to specify a single meeting room at a time when scheduling a meeting or, otherwise, unnecessarily limit the size of the available meeting time search space by specifying in the meeting request form multiple meeting rooms all of which must be available during the meeting times identified by the electronic meeting schedulers.

### SUMMARY

In one aspect, the invention features a machine-implemented method of scheduling a meeting. In accordance with this inventive method, a meeting request is received. The meeting request specifies a meeting duration, a set of non-fungible resources, and a number of required fungible resources of a specified type. A potential-meeting-time set of timeslots is determined. The potential-meeting-time set corresponding to a union of a first set of timeslots during each of which at least some of the non-fungible resources are available and a second set of timeslots corresponding to an intersection of each timeslot during which at least the specified number of fungible resources of the specified type are available. At least one timeslot having a duration at least as long as the specified meeting duration is identified in the potential-meeting-time set.

The invention also features a machine for implementing the above-described method and a machine-readable medium storing machine-readable instructions for causing a machine to implement the above-described method.

Other features and advantages of the invention will become apparent from the following description, including the drawings and the claims.

### DESCRIPTION OF DRAWINGS

FIG. 1 is a block diagram of an embodiment of a meeting scheduling system that identifies a potential meeting based on a meeting request that is received from a user.

FIG. 2 is a diagrammatic view of an implementation of a meeting request.

FIG. 3 is a diagrammatic view of an implementation of a resource profile.

FIG. 4 is a flow diagram of an embodiment of a meeting scheduling method that is implemented by the meeting scheduling system shown in FIG. 1.

FIG. 5 is a flow diagram showing the transformation of resource availability information in the course of executing the meeting scheduling method of FIG. 4.

FIG. 6 is a flow diagram of an embodiment of a method of determining a potential-meeting-time set of timeslots.

FIG. 7 is a diagrammatic view of an implementation of a meeting request in which invitees are segmented into groups with different respective attendance criteria.

FIG. 8 is a flow diagram of an embodiment of a method of determining an overall group joint availability for resources that are segmented into groups with different respective attendance criteria.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. Meeting Scheduling System Overview

The meeting scheduling embodiments described in detail below leverage the inherent fungibility of certain resources (e.g., meeting rooms and equipment satisfying specified criteria) when scheduling meetings to increase the efficiency with which meetings are scheduled. In particular, these embodiments differentiate between fungible and non-fungible resources to achieve effective and efficient search strategies for scheduling meetings, without unnecessarily limiting the scope of the available meeting time search space. In addition, these meeting scheduling embodiments provide a flexible and efficient way to handle the segmentation of resources into groups that have different respective attendance criteria.

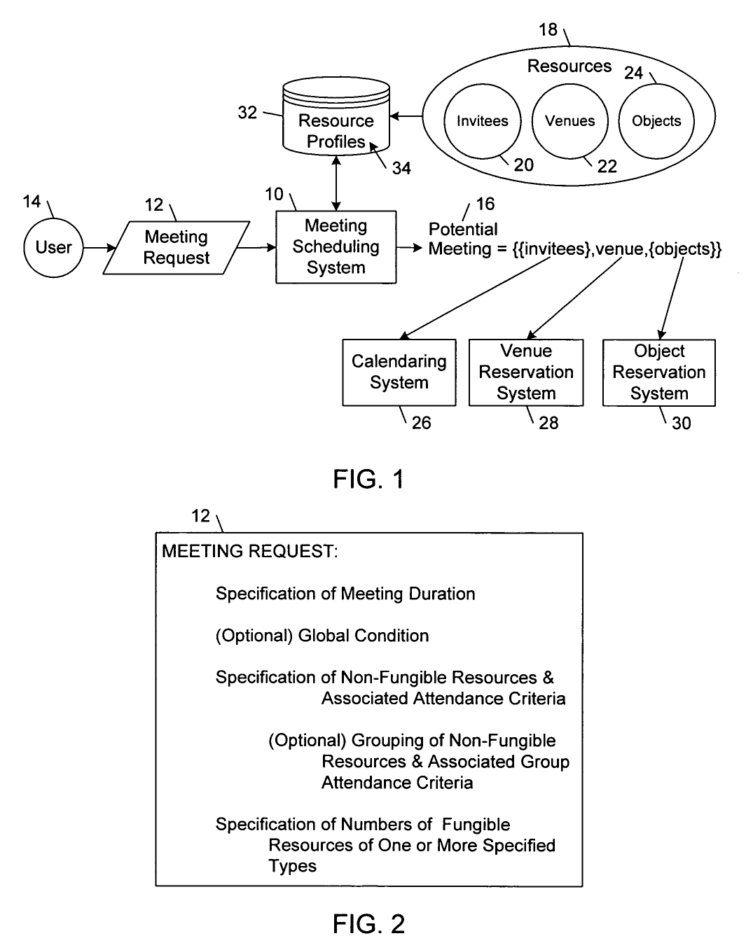

FIG. 1 shows an embodiment of a meeting scheduling system 10 that receives a meeting request 12 from a user 14 and automatically identifies a potential meeting 16 that satisfies the criteria specified in the meeting request 12. The potential meeting 16 corresponds to a date and a time during which each resource in a selected subset of a resource set 18 is available to attend a meeting at a particular venue. Among the exemplary types of resources that may be included in a scheduled meeting are invitees 20, venues 22, and objects 24. In response to the user's approval of the potential meeting 16, the meeting scheduling system 10 automatically coordinates with a calendaring system 26, a venue reservation system 28, and an object reservation system 30 to schedule the meeting with the invitees, the venue, and the objects in the subset of resources selected by the meeting scheduling system 10 for the potential meeting 16. In some implementations, the functionalities of the calendaring system 26, the venue reservation system 28, and the object reservation system 30 are integrated into a single calendaring system that maintains respective calendars for the invitees 20, the venues 22, and the objects 24 in resource set 18.

FIG. 2 shows an implementation of the meeting request 12 that includes a specification of the minimum duration of the proposed meeting. The meeting request 12 additionally may include a specification of an optional global condition, such as a scheduling period during which the desired meeting should occur (e.g., Sep. 27, 2004, through Oct. 1, 2004, between the hours of 9am-12 noon and 1 pm-4 pm). The meeting request 12 additionally includes a specification of non-fungible resources and an attendance criterion associated with each of the listed non-fungible resources. The non-fungible resources optionally may be segmented into groups, each of which is associated with a different respective attendance criterion. The meeting request 12 also includes a specification of the numbers of fungible resources of one or more specified types that are required for the meeting. The type of a fungible resource may be specified in terms of one or more attributes that are associated with the fungible resource. In the meeting request 12, the specification of the number of fungible resources of a particular type may be express or implied. For example, in some implementations, if the meeting request 12 specifies a particular venue type (e.g., a meeting room with a capacity of 25 people) without an express identification of the number of required venues of that type, the implied number of required venues of that type is one.

The meeting scheduling system 10 handles resources that are designated as non-fungible differently than resources that are designated as fungible. In particular, the meeting scheduling system 10 schedules the attendance of each non-fungible resource in accordance with its associated attendance criterion, whereas the meeting scheduling system 10 assumes that only the respective specified numbers of fungible resources of the types specified in the meeting request 12 are required to attend the meeting. In this way, the meeting scheduling system 10 allows the user 14 to identify and specify the attendance criterion for only those resources that are deemed to be non-fungible, while relying on the meeting scheduling system 10 to automatically identify the particular fungible resources that satisfy the number and type criteria specified in the meeting request 12.

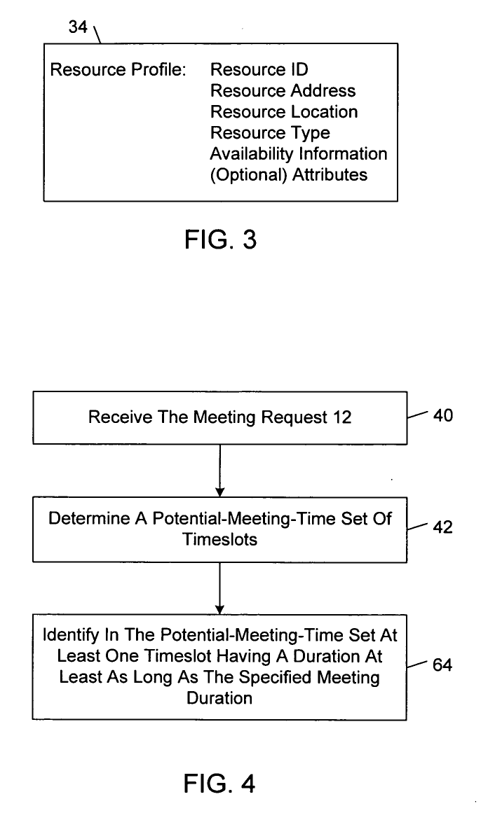

Referring to FIGS. 1 and 3, the availabilities of the invitees 20, the venues 22, and the objects 24 in the resource set 18 are monitored by the meeting scheduling system 10 and stored in respective resource profiles 34 that are maintained in a database 32. Each resource profile 34 includes a resource ID (e.g., a person's name, an employee's identification number, a venue's name, an object bar code number), a resource address (e.g., an e-mail address or a URL), a resource location corresponding to the physical location of the resource, a specification of a resource type (e.g., meeting room, laptop computer, projector), information relating to the availability of the corresponding resource, and information relating to attributes of the corresponding resource (e.g., the capacity of a meeting room, equipment included in a meeting room).

Each resource profile 34 is stored in the database 32 in the form of a data structure (e.g., an XML data structure). The resource profiles 34 may be stored in the same data structure or they may be stored in separate data structures. The database 32 is shown as a single database in the exemplary embodiment of FIG. 1. In other embodiments, the database 32 may be implemented by multiple separate databases that are distributed over a network.

The availability information that is stored in a resource profile 34 may include the normal daily hours when a resource is considered available (e.g., an employee's regular work hours and the hours when a particular venue is considered available) and the dates and times of any events that have been scheduled for the corresponding resource. In some implementations, the meeting scheduling system 10 periodically updates the availability information that is stored in the resource profiles 34 based on analyses of the electronic calendars that are maintained for the resources in the resource set 18 by the calendaring system 26, the venue reservation system 28, and the object reservation system 30.

II. Automatically Scheduling Meetings

A. Overview

FIG. 4 shows an embodiment of a meeting scheduling method that is implemented by the meeting scheduling system 10. In accordance with this method, the meeting scheduling system 10 receives the meeting request 12 from the user 14 (block 40). As explained above, the meeting request 12 includes a specification of the minimum duration of the proposed meeting, an optional scheduling period during which the desired meeting should occur, a specification of non-fungible resources and an attendance criterion for each non-fungible resource, and a specification of the respective numbers of fungible resources of one or more specified types that are required for the meeting.

The meeting scheduling system 10 determines a potential-meeting-time set of timeslots based on the received meeting request 12 and the resource profiles 34 that are maintained in the database 32 (block 42). In general, the potential-meeting-time set of timeslots corresponds to a union of a set of timeslots during s each of which at least some of the non-fungible resources are available and a set of timeslots corresponding to an intersection of each timeslot during which at least the respective specified numbers of fungible resources of the specified types are available.

The meeting scheduling system 10 identifies in the potential-meeting-time set of timeslots at least one timeslot having a duration at least as long as the specified meeting duration (block 64). Each of the identified timeslots corresponds to a potential meeting time. The meeting scheduling system 10 may present for the user's consideration some or all of the potential meeting times or it may present only the first available meeting time. In response to the user's approval of one or more of the potential meeting times, the meeting scheduling system 10 coordinates with the calendaring system 26, the venue reservation system 28, and the object reservation system 30 to schedule the approved meeting.

B. Determining A Potential-Meeting-Time Set of Timeslots

1. Overview

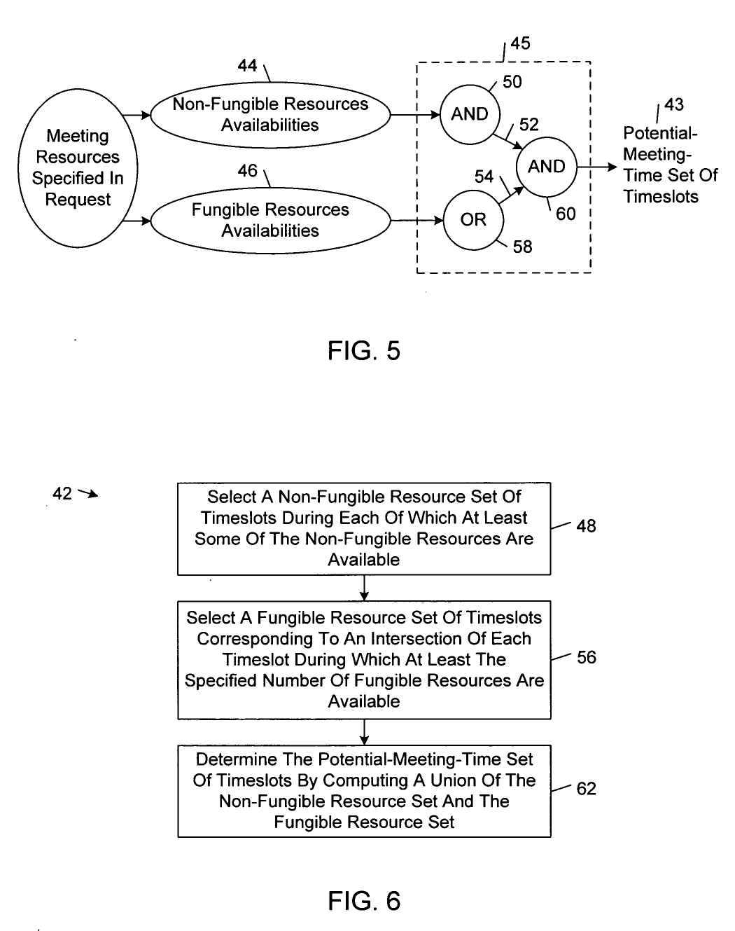

FIGS. 5 and 6 respectively show flow diagrams of the flow of resource availability information and the process steps in an embodiment of a method by which the meeting scheduling system 10 determines the potential-meeting-time set of timeslots 43 in block 42 of FIG. 4. In accordance with this method, the meeting scheduling system 10 determines in block 48 of FIG. 6 the availabilities 44 of the non-fungible resources and determines in block 56 of FIG. 6 the availabilities 46 of the fungible resources. The meeting scheduling system 10 determines these resource availabilities 44, 46 based on an analysis of the resource profiles 34 that are maintained in the database 32 for the non-fungible resources and the fungible resources that are specified in the meeting request 12. In block 62 of FIG. 6, the meeting scheduling system 10 combines the fungible and non-fungible resource availabilities 46, 44 to determine the potential-meeting-time set of timeslots 43, as shown graphically in block 45 of FIG. 5.

2. Determining Non-Fungible Resource Availabilities

a. Overview

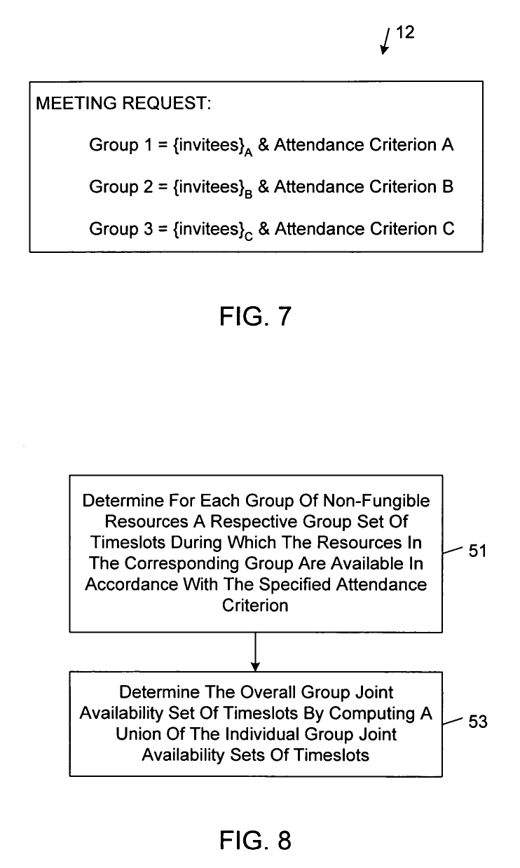

In some implementations, the meeting request 12 may designate non-fungible resources as required non-fungible resources or optional non-fungible resources. The meeting request 12 additionally may segment non-fungible resources into groups each of which has a respective attendance criterion. For example, in the exemplary meeting request shown in FIG. 7, non-fungible invitees are segmented into three groups: Group 1 consisting of a set A of invitees each of which is subject to a group attendance criterion A; Group 2 consisting of a set B of invitees each of which is subject to a group attendance criterion B; and Group 3 consisting of a set C of invitees each of which is subject to a group attendance criterion C. The group attendance criteria may specify any rule for determining the attendance of the members of the group. Examples of group attendance criteria are: attendance of all members of the group is required; attendance of all members of the group is optional; and attendance of at least N members of the group is required, where N is a positive integer less than or equal to the total number of non-fungible resources in the group.

The meeting scheduling system 10 determines the availabilities 44 of the non-fungible resources by selecting a non-fungible resource set of timeslots during each of which at least some of the non-fungible resources are available (block 48; FIG. 6). In this process, the meeting scheduling system 10 determines a joint availability (illustrated graphically in block 50 of FIG. 5) for the non-fungible resources based on their associated attendance criteria that are specified in the meeting request 12.

b. Required Non-Fungible Resources

With respect to required non-fungible resources, the meeting scheduling system 10 determines a first set of timeslots corresponding to a union (or, equivalently, computes the logical AND) of all of the timeslots during which all of the required non-fungible resources are available. In some implementations, the meeting scheduling system 10 excludes from the first set any timeslots that are shorter than the meeting duration specified in the meeting request 12.

Referring to FIG. 8, the meeting scheduling system 10 also determines a respective group joint availability for each group of non-fungible resources that is specified in the meeting request 12. The meeting scheduling system 10 determines for each group of non-fungible resources a group joint availability corresponding to a respective group set of timeslots (within any specified scheduling period) during which the non-fungible resources in the corresponding group are available in accordance with the group attendance criterion specified for the group (block 51). The meeting scheduling system 10 then determines an overall group joint availability set of timeslots by computing a union of the group joint availabilities determined for each group of non-fungible resources specified in the meeting request (block 53).

The meeting scheduling system 10 determines the non-fungible resource set of timeslots 52 shown in FIG. 5 by computing a union of the first set of timeslots during which all of the required non-fungible resources are available with the overall group joint availability set of timeslots computed in block 53 of FIG. 8.

c. Optional Non-Fungible Resources If the meeting request 12 specifies any optional non-fungible resources, the meeting scheduling system 10 also determines the total number of optional non-fungible resources that are available during each of the timeslots in the non-fungible resource set of timeslots 52 (FIG. 5). The meeting scheduling system 10 labels or tags each of the timeslots 52 in the non-fungible resource set with the computed total number values. In some implementations, the meeting scheduling system 10 labels each of the timeslots 52 with a respective absolute or scaled measure of the amount by which the number of optional non-fungible resources exceeds the group attendance criterion specified for the non-fungible resources in the corresponding group. The labels or tags are used by the meeting scheduling system 10 to rank the timeslots in the potential-meeting-time set of timeslots 43, as explained in detail below.

3. Determining Fungible Resource Availabilities Referring back to FIGS. 5 and 6, after the non-fungible resource set of timeslots 52 has been selected and optionally labeled (block 48; FIG. 6), the meeting scheduling system 10 selects a fungible resource set of timeslots 54 (block 56; FIG. 6). In this process, the meeting scheduling system 10 determines a joint availability (illustrated graphically in block 58 of FIG. 5) for the fungible resources based on their associated attendance criteria that are specified in the meeting request 12. The determination of the joint availability for the fungible resources corresponds to the computation of an intersection (or, equivalently, the logical OR) of each timeslot during which at least the respective specified number of fungible resources of the specified type are available. If the meeting request 12 specifies required numbers of multiple types of fungible resources, the meeting scheduling system 10 computes a respective joint availability for each type of fungible resource corresponding to an intersection of each timeslot during which at least the specified number of fungible resources of the corresponding type are available. The meeting scheduling system 10 then determines the fungible resource set of timeslots 54 shown in FIG. 5 by computing the union of the joint availabilities computed for all of the specified types of fungible resources.

In the process of determining the fungible resource set of timeslots 54, the meeting scheduling system 10 compares the fungible resource attributes specified in the meeting request 12 and the attributes specified in the corresponding resource profiles 34 and excludes from consideration the resources with attributes that do not meet the specifications in the meeting request 12. In some cases, the set of fungible resources under consideration is a dynamic function of the availability of different groups of resources with different attendance criteria. For example, the meeting request 12 may specify a number of required and optional invitees and a meeting room with a certain invitee capacity attribute. In this case, the number of invitees in each timeslot in the non-fungible resource set 52 may vary depending on the number of optional invitees that are available. With respect to this example, the meeting scheduling system 10 logically compares the labels associated with each of the timeslots in the non-fungible resource set of timeslots 52 with the corresponding room capacity attribute to exclude fungible resources that do not meet the specified capacity criterion.

4. Determining the Potential-Meeting-Time Set of Timeslots

After the non-fungible resource set of timeslots 52 and the fungible resource set of timeslots 54 have been selected in accordance with blocks 48, 56 of FIG. 6, the meeting scheduling system 10 determines the potential-meeting-time set of timeslots 43 (FIG. 5) by computing a union (illustrated graphically in block 60 of FIG. 5) of the non-fungible resource set of timeslots 52 and the fungible resource set of timeslots 54 in block 62 of FIG. 6.

C. Identifying Potential Meeting Times

Referring back to FIG. 4, after the potential-meeting-time set of timeslots 43 has been determined (block 42), the meeting scheduling system 10 identifies in the potential-meeting set of timeslots 43 at least one timeslot having a duration at least as long as the specified meeting duration (block 64). In some implementations, the meeting scheduling system 10 ranks the timeslots in order from the largest to the smallest of the label values (e.g., values corresponding to the total numbers of optional non-fungible resources available during the respective timeslots in the potential-meeting-time set or to the absolute or scaled measures of the amounts by which the number of optical non-fungible resources exceeds the corresponding group attendance criteria). The meeting scheduling system 10 may present for the user's consideration some or all of the potential meeting times in rank-order or it may present only the first available potential meeting time. In response to the user's approval of one of the potential meeting times, the meeting scheduling system 10 coordinates with the calendaring system 26, the venue reservation system 28, and the object reservation system 30 to schedule the approved meeting.

III. Meeting Scheduling System Architecture

The meeting scheduling system 10 may be implemented as one or more respective software modules operating on a computer. In one embodiment, the meeting scheduling system 10 may be implemented as a plug-in module in a calendaring application program (e.g., the Microsoft® Outlook® application program or the IBM® Lotus Notes® application program) that is operable on a personal computer. In general, the meeting scheduling system 10 may be implemented, in part, in a computer process product tangibly embodied in a machine-readable storage device for execution by a computer processor. In some embodiments, the meeting scheduling system 10 preferably is implemented in a high level procedural or object-oriented processing language. In other embodiments, the meeting scheduling system 10 is implemented in assembly or machine language, if desired. In any case, the processing language may be a compiled or interpreted language. The methods implemented by the meeting scheduling system 10 may be performed by a computer processor executing instructions organized, for example, into process modules to carry out these methods by operating on input data and generating output.

Other embodiments are within the scope of the claims.

What is claimed is:

1. A machine-implemented method of scheduling a meeting, comprising:
receiving a meeting request specifying a meeting duration, a set of non-fungible resources, and a number of required fungible resources of a specified type;
determining a potential-meeting-time set of timeslots corresponding to a union of a first set of timeslots during each of which at least some of the non-fungible resources are available and a second set of timeslots corresponding to an intersection of each timeslot during which at least the specified number of fungible resources of the specified type are available; and
identifying in the potential-meeting-time set at least one timeslot having a duration at least as long as the specified meeting duration.

2. The method of claim 1, wherein the meeting request designates at least one of the non-fungible resources a required non-fungible resource, and further comprising selecting for the first set timeslots during each of which all of the required non-fungible resources are available.

3. The method of claim 1, wherein the meeting request designates at least one of the non-fungible resources an optional non-fungible resource, and further comprising determining total numbers of the optional non-fungible resources that are available during each of the timeslots in the potential-meetings time set.

4. The method of claim 3, further comprising presenting timeslots in the potential-meeting-time set in accordance with the determined total number of available optional non-fungible resources.

5. The method of claim 1, wherein the meeting request segments non-fungible resources into at least two groups and assigns to each group a different respective attendance criterion.

6. The method of claim 5, wherein the determining of the potential-meeting-time set of timeslots comprises determining a union of the second set of timeslots and a respective group availability set of timeslots for each group of non-fungible resources specified in the meeting request, each group availability set corresponding to a set of timeslots during which the non-fungible resources in the corresponding group are available in accordance with the assigned attendance criterion.

7. The method of claim 1, wherein the meeting request specifies required numbers of multiple respective types of fungible resources.

8. The method of claim 7, wherein the determining of the potential-meeting-time set of timeslots comprises determining a union of the first set of timeslots and a respective fungible resource set of timeslots for each type of fungible resource specified in the meeting request, each fungible resource set corresponding to an intersection of each timeslot during which at least the specified required number of fungible resources of the corresponding type are available.

9. The method of claim 1, wherein the type of fungible resource is specified by a fungible resource attribute set containing at least one attribute.

10. The method of claim 9, further comprising determining a set of fungible resources by identifying resources having the attributes in the specified fungible resource attribute set.

11. The method of claim 1, wherein the received meeting request additionally specifies a global condition for the meeting, and the determining of the potential-meeting-time set of timeslots comprises applying the global condition to a set of timeslots selected from the first set, the second set, and the union of the first and second sets of timeslots.

12. A machine-implemented method of scheduling a meeting, comprising:
receiving a meeting request specifying a meeting duration and two or more groups of resources each assigned a different respective attendance criterion;
determining for each group a respective group set of timeslots during which the non-fungible resources in the corresponding group are available in accordance with the assigned attendance criterion;
determining a potential-meeting-time set of timeslots corresponding to a union of all the group sets of timeslots; and
identifying in the potential-meeting-time set at least one timeslot having a duration at least as long as the specified meeting duration.

13. The method of claim 12, wherein at least one of the groups is assigned a required attendance criterion, and the set of timeslots determined for each required attendance group corresponds to timeslots during each of which all of the resources in the corresponding required attendance group is available.

14. The method of claim 12, wherein at least one of the groups is assigned a respective minimal number attendance criterion specifying a respective minimal number of required resources from the corresponding group, and the set of timeslots determined for each group assigned a minimal number attendance criterion corresponds to timeslots during each of which at least the minimal number of the resources in the corresponding group is available.

15. A machine-readable medium storing machine-readable instructions for causing a machine to perform operations comprising:
receiving a meeting request specifying meeting parameters comprising a meeting duration, a set of non-fungible resources, and a number of required fungible resources of a specified type;
determining a potential-meeting-time set of timeslots corresponding to a union of a first set of timeslots during each of which at least some of the non-fungible resources are available and a second set of timeslots corresponding to an intersection of each timeslot during which at least the specified number of fungible resources of the specified type are available; and
identifying in the potential-meeting-time set at least one timeslot having a duration at least as long as the specified meeting duration.

16. The machine-readable medium of claim 15, wherein the meeting request additionally comprises a designation of at least one of the non-fungible resources as a required non-fungible resource, and the machine-readable instructions cause the machine to perform operations comprising selecting for the first set timeslots during each of which all of the required non-fungible resources are available.

17. The machine-readable medium of claim 15, wherein the meeting request additionally comprises a designation of at least one of the non-fungible resources as an optional non-fungible resource, and the machine-readable instructions cause the machine to perform operations comprising determining total numbers of the optional non-fungible resources that are available during each of the timeslots in the potential-meeting-time set.

18. The machine-readable medium of claim 15, wherein the meeting request additionally comprises a segmentation of non-fungible resources into at least two groups and an assignment to each group a different respective attendance criterion, and the machine-readable instructions cause the machine to perform operations comprising determining a union of the second set of timeslots and a respective group availability set of timeslots for each group of non-fungible resources specified in the meeting request, each group availability set corresponding to a set of timeslots during which the non-fungible resources in the corresponding group are available in accordance with the assigned attendance criterion.

19. The machine-readable medium of claim 15, wherein the meeting request additionally comprises a specification of a required numbers of multiple respective types of fungible resources, and the machine-readable instructions cause the machine to perform operations comprising determining a union of the first set of timeslots and a respective fungible resource set of timeslots for each type of fungible resource specified in the meeting request, each fungible resource set corresponding to an intersection of each timeslot during which at least the specified required number of fungible resources of the corresponding type are available.

20. The machine-readable medium of claim 15, wherein the type of fungible resource is specified by a fungible resource attribute set containing at least one attribute, and the machine-readable instructions cause the machine to perform operations comprising determining a set of fungible resources by identifying resources having the attributes in the specified fungible resource attribute set.

21. A machine-readable medium storing machine-readable instructions for causing a machine to perform operations comprising:
receiving a meeting request specifying a meeting duration and two or more groups of resources each assigned a different respective attendance criterion;
determining for each group a respective group set of timeslots during which the non-fungible resources in the corresponding group are available in accordance with the assigned attendance criterion;
determining a potential-meeting-time set of timeslots corresponding to a union of all the group sets of timeslots; and
identifying in the potential-meeting-time set at least one timeslot having a duration at least as long as the specified meeting duration.

22. A machine for scheduling a meeting, comprising at least one processing module operable to perform operations comprising:
receiving a meeting request specifying a meeting duration, a set of non-fungible resources, and a number of required fungible resources of a specified type;
determining a potential-meeting-time set of timeslots corresponding to a union of a first set of timeslots during each of which at least some of the non-fungible resources are available and a second set of timeslots corresponding to an intersection of each timeslot during which at least the specified number of fungible resources of the specified type are available; and
identifying in the potential-meeting-time set at least one timeslot having a duration at least as long as the specified meeting duration.

23. A machine for scheduling a meeting, comprising at least one processing module operable to perform operations comprising: receiving a meeting request specifying a meeting duration and two or more groups of resources each assigned a different respective attendance criterion;
determining for each group a respective group set of timeslots during which the non-fungible resources in the corresponding group are available in accordance with the assigned attendance criterion;
determining a potential-meeting-time set of timeslots corresponding to a union of all the group sets of timeslots; and
identifying in the potential-meeting-time set at least one timeslot having a duration at least as long as the specified meeting duration.
